(19) United States
(12) Patent Application Publication
(10) Pub. No.: US 2017/0350230 A1
(43) Pub. Date: Dec. 7, 2017

(54) Apparatus and Method for Detection of Corrosion

(71) Applicant: Scale Protection AS, Harstad (NO)

(72) Inventor: Ole Magnar Drønen, Harstad (NO)

(73) Assignee: Scale Protection AS, Harstad (NO)

(21) Appl. No.: 15/545,772

(22) PCT Filed: Feb. 11, 2016
(86) PCT No.: PCT/NO2016/050020

§ 371 Date: Jul. 24, 2017

(30) Foreign Application Priority Data
Feb. 25, 2015 (NO) 20150263

(51) Int. Cl. E21B 47/00; C23F 13/22; C23F 13/10; G01N 17/04; E21B 41/02

(52) U.S. Cl. CPC E21B 47/00; G01N 17/04; E21B 41/02; C23F 13/10; C23F 13/22; C23F 2213/32

(57) ABSTRACT

An apparatus is for detecting corrosion in an internal pipe bore in a pipeline. A tracer chamber containing a first tracer is formed in a portion of the pipeline and is bounded towards the internal pipe bore by a chamber wall having a first corrosion resistance and including at least one wall portion with a second corrosion resistance, the second corrosion resistance being smaller than the first corrosion resistance. A method is for detecting corrosion in an internal pipe bore in a pipeline.

### FIELD

An apparatus and a method for detecting corrosion in an internal pipe bore in a pipeline are described.

### BACKGROUND

Corrosion represents great challenges in terms of economy, safety and operation. For elements which can be inspected regularly, for example a ship's hull, bridge structures and similar supporting structures, extensive systems have been developed for monitoring and warning of hazardous conditions, whereas for other elements, especially underground wells for the recovery of hydrocarbons, there is a lack of sufficiently simple, reliable systems which do not prevent the ordinary operation of a well. Typically, monitoring the corrosive state of a well pipe by means of sensors will involve the installation of signal communication equipment in the well, for example the extension of signal lines. Naturally, such equipment will take up space and it may easily become damaged when other well equipment is being moved.

U.S. Pat. No. 2,994,778 A1 discloses a method and an apparatus for investigation the corrosion rate of corrosion-sensitive materials of construction disposed in not readily-accessible positions and exposed to a continually flowing fluid stream, more particularly with the use of radioactive tracers for the investigation of the corrosion rate of materials in a construction exposed to a corrosive environment within a well bore traversing a fluid-producing geological formation. A container 20 containing a radio-active material soluble in the fluid stream comprises at least one portion provided by a corrosion sensitive material of known thickness such that perforation resulting from corrosion will occur within a desired time. The radioactive material is disposed over a short period.

U.S. Pat. No. 4,922,748 A1 is disclosing a method of monitoring thinning of pipe walls in a piping system including selecting locations to be monitored, normally those pipes particularly susceptible to thinning from erosion/corrosion, boring holes in the outer surfaces of the pipes at the selected locations to depths greater than the thickness at which the pipes will rupture to leave predetermined residual wall thicknesses between the ends of the holes and the inner surfaces of the pipe walls, inserting tracer materials in the holes to be released in the pipes when pipe wall thinning of the inside if the pipe exceeds the residual wall thicknesses of the holes, and determining the presence or absence of tracer materials in the holes to permit pipe wall thinning to be determined prior to pipe rupture allowing repair or replacement during scheduled downtime of the piping system. Preferably, a series of spaced holes are bored to differing depths at each location such that, knowing the difference in depth and thus residual thickness between holes and the time period between detection of tracer materials from each hole, the rate of pipe wall thinning can be determined, and the period of time in which the pipe can be safely repaired can be calculated.

US 20120118564 A1 discloses a system and methodology for detecting and monitoring erosion in various environments, including downhole environments. A tracer element is located in a chamber of a sacrificial element such that sufficient erosion of said element due to fluid flow exposes the tracer element. A monitoring system is disposed for cooperation with the tracer element such that exposure of the tracer element is detected by the monitoring system. The monitoring system outputs appropriate data indicative of the erosion to enable adjustments to the fluid flow.

### SUMMARY

The invention has for its object to remedy or reduce at least one of the drawbacks of the prior art or at least provide a useful alternative to the prior art.

The object is achieved through the features, which are specified in the description below and in the claims that follow.

Internally in a well-pipe body arranged to be placed as part of a fluid-flow-carrying pipeline, one or more chambers provided with a tracer are arranged, at least a portion of a chamber wall which faces a fluid-flow path in the pipeline being formed of a material with less resistance to corrosion than the rest of the structures of the pipeline. Thereby it is possible to provide a system which, in an early phase of the development of corrosion, long before the main structure of the pipeline has been weakened, gives a remote-readable indication that the pipeline is being subjected to corrosion, as an early corroding-through of the “weak” wall portion of the tracer chamber gives the tracer safe passage into the fluid flow where it is carried with the fluid flow and can be detected by analyses remotely from the tracer chamber, for example at a valve node of a pipeline, in a wellhead of a petroleum well et cetera, so that necessary action can be taken. The occurrence of tracers can be monitored in various ways. In pipe systems that are, to a great extent, inaccessible to human beings, the monitoring may occur by means of automatic registration with transmission of the measuring result to operation and control systems, for example in a control room on a surface installation in a hydrocarbon-production field or at an operation facility controlling and monitoring a pipeline network.

Said portions of the tracer-chamber wall may be given less resistance to corrosion than the rest of the structures of the pipeline by several different means. Types of materials that in themselves have less specific resistance to corrosion than the rest of the structures may be used; the same types of materials as in the rest of the pipeline may be used, but with a smaller material thickness; portions of the chamber wall may be subjected to stress through structural measures, that is to say have a load applied to them, increasing the material stress, which then encourages corrosion.

It is an advantage if the tracer chamber is annular, or that several chambers are evenly distributed around the internal periphery of the pipeline. Thereby corrosion is discovered more easily, even if, for various reasons, its occurrence differs along the internal periphery of the pipeline, which may be caused by the corrosion-encouraging substances being unevenly distributed in the pipeline cross section, for example a separation of substances of different specific weights across the cross section of a lying pipe.

In a further aspect of the invention, a second chamber filled with a second tracer may be enclosed in a sacrificial material which is used in the pipeline to inhibit corrosion, typically in the form of sacrificial anodes of zinc, in such a way that a hole is only corroded into the second chamber when a substantial part of the sacrificial-material mass has been consumed (sacrificed). When the second tracer is then found in the fluid flow, this is an indication of the sacrificial material being in the process of being used up. This embodiment may be used alone or it may be used in combination with the embodiment of the invention mentioned first. In the latter, combined use of the embodiments of the invention, detection of the second tracer alone will only give an indication of the corrosion-inhibiting material being substantially used up, whereas detection of the corrosion-indicating tracer that is used in the first embodiment of the invention is a sign of the structures of the pipeline corroding.

It may be an advantage to arrange the tracer chamber integrally in a pipe section, which is joined, whenever required, into the pipeline, which is to be monitored, possibly in an insert, which may be inserted into the pipeline and anchored in a suitable place.

It may also be an advantage to arrange the tracer chamber in connection with further pipe sections or inserts, which provide further remote-readable state information by means of tracers, which are released from further tracer chambers and found in the fluid flow remotely from the respective tracer depot. Of such further tools are mentioned apparatuses for monitoring scaling, monitoring the occurrence of previously injected inhibitors returned from a production structure, and so on.

The invention is defined by the independent claims. The dependent claims define advantageous embodiments of the invention.

In a first aspect, the invention relates more specifically to an apparatus for detecting corrosion in an internal pipe bore in a pipeline, wherein a tracer chamber, which contains a first tracer, being formed in a portion of the pipeline and being bounded towards the internal pipe bore by means of a chamber wall having a first corrosion resistance and including at least one wall portion with a second corrosion resistance, the second corrosion resistance being smaller than the first corrosion resistance, characterized in that said first tracer is arranged in porous polymer rods.

The reduced corrosion resistance of the at least one wall portion may be provided by said wall portion having a wall thickness smaller than the general wall thickness of the chamber wall.

The reduced corrosion resistance of the at least one wall portion may alternatively or additionally be provided by the use of a material with less corrosion resistance than the material forming the remaining part of the chamber wall.

The reduced corrosion resistance of the at least one wall portion may alternatively or additionally be provided by structural means, such as tensioning said wall portion against adjacent chamber-wall elements in order thereby to increase the material stress in said wall portion.

The tracer chamber may be annular and surround the periphery of the internal pipe bore.

In a second aspect, the invention relates more specifically to an apparatus assembly, which includes the apparatus as described above, in which a sacrificial anode, which is arranged to be placed in the pipe bore includes a second chamber, which is filled with a second tracer.

In a third aspect, the invention relates more specifically to an apparatus assembly, which includes the apparatus as described above, the apparatus assembly including one or more further apparatuses taken from the group comprising scale-control apparatus, scale-detection apparatus and inhibitor-detection apparatus.

In a fourth aspect, the invention relates more specifically to a method for detecting corrosion in an internal pipe bore in a pipeline, characterized by the method including the steps:

a) arranging a first tracer in porous polymer rods in a first chamber separated from the pipe bore by means of a chamber wall with a first corrosion resistance;

b) forming at least one chamber-wall portion with a second corrosion resistance which is smaller than the first corrosion resistance;

c) bringing the chamber wall and the at least one chamber-wall portion into contact with a corrosive fluid flow;

d) by corrosion, perforating the at least one chamber-wall portion having reduced corrosion resistance;

e) dissolving the first tracer in the fluid flow; and

f) detecting the first tracer in the fluid flow by means of a tracer detector placed downstream, as an indication of the pipe bore corroding.

The method may include the further steps:

g) arranging a second tracer in a chamber in a sacrificial anode;

h) placing the sacrificial anode upstream of the first tracer chamber;

i) releasing a corrosion-inhibiting sacrificial material from the sacrificial anode into the fluid flow and depositing the sacrificial material in the pipe bore downstream of the sacrificial anode;

j) releasing the second tracer into the fluid flow in consequence of the sacrificial material having been substantially consumed from the sacrificial anode; and

k) detecting the second tracer in the fluid flow by means of a tracer detector placed down-stream, as an indication of the sacrificial anode having been substantially consumed and corrosion of the pipe bore being expectable.

### BRIEF DESCRIPTION OF THE DRAWINGS

In what follows, an example of a preferred embodiment is described, which is visualized in the accompanying drawings in which:

FIG. 1 shows an axial section through a portion of a pipeline provided with a pipe section including an annular tracer chamber in which, in an internal tracer-chamber wall, wall portions having less corrosion resistance than the rest of the internal tracer-chamber wall are indicated;

FIG. 2 shows an axial section, on a larger scale, through an annular sacrificial anode, that is to say a sacrificial material that inhibits corrosion on adjacent structures by its galvanic effect, a second tracer being enclosed in a second chamber in the sacrificial anode; and

FIG. 3 shows an axial section, on a smaller scale, through a larger portion of the pipeline including pipe sections provided with apparatus for scale control and detection, an apparatus for detecting return flow of previously injected inhibitors, and an apparatus according to the invention for detecting corrosion.

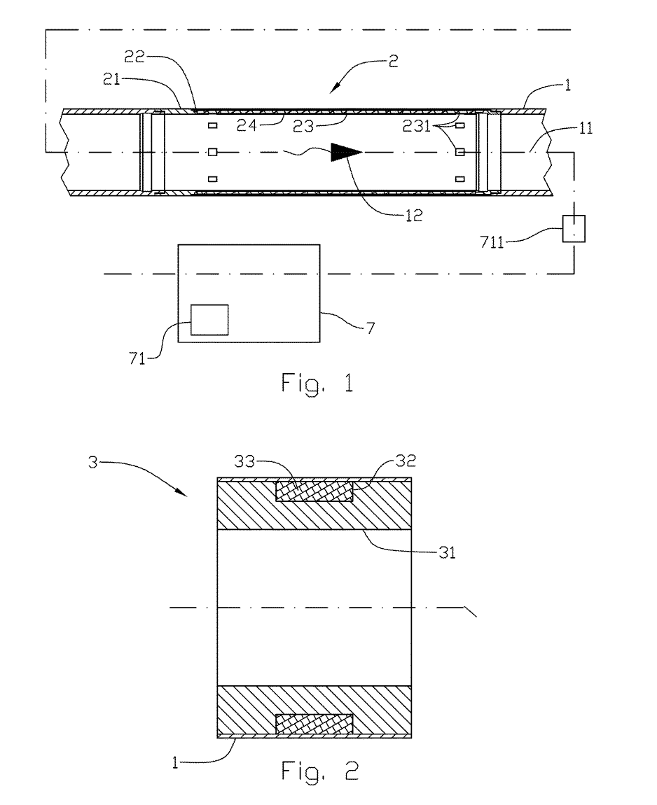

### DETAILED DESCRIPTION OF THE DRAWINGS

In the figures, the reference numeral 1 indicates a pipeline to be monitored. Even though the figures substantially relate to a well pipe, the invention may also relate to other types of pipelines, for example pipelines for conveying fluids on land and at sea, characterized by being pipelines that are subjected to internal corrosion which is difficult to detect because of the pipeline being difficult to access because of the surroundings, the distance to a personnel base, or the fact that great challenges are involved in stopping the fluid flow through the pipeline for an internal, visual check to be carried out.

The pipeline 1 is connected to a control room 7 where appropriate systems 71 are installed for the operation and control of the pipeline 1 and a fluid flow 12 in an internal pipe bore 11 in the pipeline 1.

In a portion of the pipeline 1 where it is desirable to monitor the development of corrosion in the pipe bore 11, a corrosion-detection apparatus 2 is arranged. Here, the apparatus 2 is formed in a separate pipe section 21 in which an annular tracer chamber 22 is arranged, extending uninterruptedly around the entire periphery of the pipe bore 11 and substantially in the entire length of the pipe section 21. An internal chamber wall 23 bounds the tracer chamber 22 towards the pipe bore 11. The chamber wall 23 includes several portions 231 with a corrosion resistance CR₂, which is smaller than the general corrosion resistance CR, of the elements forming the pipe bore 11, and thereby also smaller than the general corrosion resistance CR, of the chamber wall 23. It is indicated here by said portions 231 having a smaller wall thickness than the internal chamber wall 23 in general. This wall thickness is so small that a correspondingly deep corrosion in the internal structure of the pipeline 1 will not have a critical effect on the strength of the pipeline 1. Said wall portions 231 may be given a weakened corrosion resistance also by other means, for example by the choice of a material with less specific corrosion resistance than the materials that are used in the pipeline 1 in general, or by said portions being subjected to greater material stresses, that is to say being strained more than the chamber wall 23 in general, by structural means, for example by being tensioned against adjacent chamber-wall elements (not shown).

Said chamber 22 is filled with a tracer 24. The tracer may be of any kind, which is suitable for dissolving in the fluid flow 12, which is to be carried through the pipe bore 11. The tracer is typically arranged in porous polymer rods.

Downstream of the corrosion-detection apparatus 2, the pipeline 1 is provided with at least one tracer detector 711 connected in a signal-communicating manner to the operation and control system 71. The tracer detector 711 is preferably arranged in some place on the pipeline 1 where it is easy to supply energy for the operation of the tracer detector 711 and where a connection can easily be established for the transmission of control signals et cetera between said detector 711 and the operation and control system 71. For a production well in a hydrocarbon field, it is obvious to place a tracer detector 711 on or at a wellhead (not shown). For a transport pipeline, a favourable place may be at a pump station (not shown).

When the wall 23 of the tracer chamber 22 has been corroded through, the tracer 24 is released and carried in the fluid flow 12 through the pipeline 1. The tracer detector 711 registers the occurrence of the tracer 24 and the operation and control system 71 indicates that the corrosion in the pipeline has reached a certain level.

If the corrosion-detection apparatus 2 includes several tracer chambers 22, each with chamber wall portions 231 with different resistances to corrosion and with different tracers, the operation and control system 71 may indicate when the corrosion in the pipeline has reached further, higher levels.

Reference is now made to FIG. 2. Here, a second tracer 33 is shown enclosed in a second tracer chamber 32 arranged in a sacrificial anode 3, that is to say a depot containing a sacrificial material 31, typically zinc, which may be placed in a suitable place in the pipeline 1 to protect the interior of the pipeline 1 from corrosion. When the second tracer 33 is found in the fluid flow 12 in the pipeline 1 by means of the tracer detector 711, this may be taken as a signal of the sacrificial material 31 being nearly spent, lopment of corrosion in the pipeline 1 may be expected.

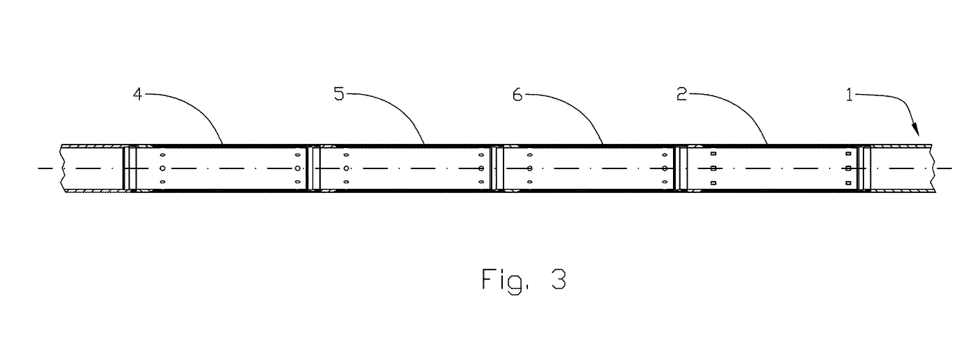

In FIG. 3, an assembly of several different apparatuses for detecting conditions in a pipeline 1, especially in a hydrocarbon well, by means of tracers is shown. A scale-control apparatus 4 may, for example, provoke early scaling to give an indication of whether the environment in the well involves a risk of developing scale. A scale-detection apparatus 5 gives an indication of how far the scale has developed. An inhibitor-detection apparatus 6 may give an indication of whether a structure is still releasing a previously injected inhibitor, for example a production-promoting inhibitor. Finally, the assembly includes a corrosion-detection apparatus 2 according to the invention.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive. The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. An apparatus for detecting corrosion in an internal pipe bore in a pipeline, the apparatus comprising a tracer chamber containing a first tracer and being formed in a portion of the pipeline and bounded towards the internal pipe bore by a chamber wall having a first corrosion resistance and further comprising at least one wall portion with a second corrosion resistance, the second corrosion resistance being smaller than the first corrosion resistance, wherein said first tracer is arranged in porous polymer rods.

2. The apparatus according to claim 1, wherein the reduced corrosion resistance of the at least one wall portion is provided by said wall portion having a wall thickness smaller than the general wall thickness of the chamber wall.

3. The apparatus according to claim 1, wherein the reduced corrosion resistance of the at least one wall portion is provided by the use of a material with less corrosion resistance than the material forming the remaining part of the chamber wall.

4. The apparatus according to claim 1, wherein the reduced corrosion resistance of the at least one wall portion is provided by structural means such as tensioning said wall portion against adjacent chamber-wall elements in order thereby to increase the material stress in said wall portion.

5. The apparatus according to claim 1, wherein the tracer chamber is annular and surrounds the periphery of the internal pipe bore.

6. An apparatus assembly comprising:
a tracer chamber containing a first tracer and being formed in a portion of the pipeline and bounded towards the internal pipe bore by a chamber wall having a first corrosion resistance and further comprising at least one wall portion with a second corrosion resistance, the second corrosion resistance being smaller than the first corrosion resistance, wherein said first tracer is arranged in porous polymer rods;
wherein a sacrificial anode which is arranged to be placed in the pipe bore includes a second chamber which is filled with a second tracer.

7. An apparatus assembly comprising:
a tracer chamber containing a first tracer and being formed in a portion of the pipeline and bounded towards the internal pipe bore by a chamber wall having a first corrosion resistance and further comprising at least one wall portion with a second corrosion resistance, the second corrosion resistance being smaller than the first corrosion resistance, wherein said first tracer is arranged in porous polymer rods;
wherein the apparatus assembly includes one or more further apparatuses selected from the group consisting of a scale-control apparatus, a scale-detection apparatus and an inhibitor-detection apparatus.

8. A method for detecting corrosion in an internal pipe bore in a pipeline, the method comprising:
a) arranging a first tracer in porous polymer rods in a first chamber separated from the pipe bore by a chamber wall having a first corrosion resistance;
b) forming at least one chamber-wall portion with a second corrosion resistance which is smaller than the first corrosion resistance;
c) bringing the chamber wall and the at least one chamber-wall portion into contact with a corrosive fluid flow;
d) by corrosion, perforating the at least one chamber-wall portion with reduced corrosion resistance;
e) dissolving the first tracer in the fluid flow; and
f) detecting the first tracer in the fluid flow by means of a tracer detector placed downstream, as an indication of the pipe bore corroding.

9. The method according to claim 8, further comprising:
g) arranging a second tracer in a chamber in a sacrificial anode;
h) placing the sacrificial anode upstream of the first tracer chamber;
i) releasing a corrosion-inhibiting sacrificial material from the sacrificial anode into the fluid flow and depositing the sacrificial material in the pipe bore downstream of the sacrificial anode;
j) releasing the second tracer into the fluid flow in consequence of the sacrificial material having been substantially consumed from the sacrificial anode; and
k) detecting the second tracer in the fluid flow by means of a tracer detector placed downstream, as an indication of the sacrificial anode having been substantially consumed and corrosion of the pipe bore being expectable.
